(19) United States
(12) Patent Application Publication
(10) Pub. No.: US 2014/0297721 A1
(43) Pub. Date: Oct. 2, 2014

(54) SERVER CLUSTER DEPLOYMENT SYSTEM AND SERVER CLUSTER DEPLOYMENT METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: GUANG-JIAN WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/066,708

(22) Filed: Oct. 30, 2013

(30) Foreign Application Priority Data
Mar. 29, 2013 (CN) 2013101054589

(51) Int. Cl. H04L 29/06

(52) U.S. Cl. CPC H04L 67/42
USPC 709/203

(57) ABSTRACT

A server cluster deployment method includes obtaining an operation system image from a server and loading an operation system corresponding to the operation system image on a father terminal. The operation system image is stored in a storage module of the father terminal. A child terminal requests the operating system image from the father terminal. If a number of child terminals that have obtained the operating system image from the father terminal is less than a preset value, the father terminal transmits the operation system image to the child terminal. If the number of child terminals that have obtained the operating system image from the father terminal is greater than the preset value, the request is transferred to another father terminal to transmit the operating system to the child terminal.

### BACKGROUND

1. Technical Field

The present disclosure relates to a server cluster deployment system and a server cluster deployment method.

2. Description of the Related Art

Customer terminals obtain operating system images from a server to run an operating system in the customer terminals. However, when too many customer terminals obtain the operating system images from the server at the same time, a transmission speed of the operating system images is reduced.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a server cluster deployment system.

FIG. 2 is a flowchart of a server cluster deployment method.

### DETAILED DESCRIPTION

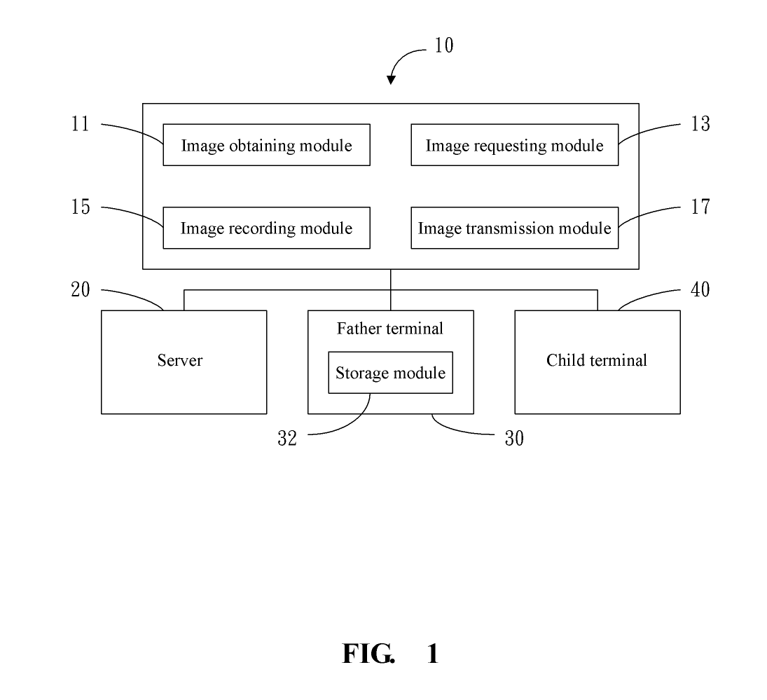

FIG. 1 shows a block diagram of a server cluster deployment system 10 according to an exemplary embodiment. The server cluster deployment system 10 includes a server 20, a number of father terminals 30, and a number of child terminals 40. The server 20 is configured to provide an operating system image to the father terminals 30 and the child terminals 40. The operation system image is configured to load an operating system corresponding to the operation system image on the father terminals 30 and the child terminals 40 for users to operate. Each father terminal 30 includes a storage module 32.

The server cluster deployment system 10 includes an image obtaining module 11, an image requesting module 13, an image recording module 15, and an image transmission module 17.

The image obtaining module 11 is configured to obtain the operation system image from the server 20 and load the operation system on a father terminal 30 for the user of the father terminal 30 to operate. The image obtaining module 11 is further configured to store the operation system image in the storage 32 of the father terminal 30. The image requesting module 13 is configured to send an operating system image request to a father terminal 30 in response to a child terminal 40 requesting the operating system image.

The image recording module 15 is configured to record a number of the child terminals 40 that have obtained the operation system image from the father terminal 30 and determines whether the number is less than a preset value. The image transmitting module 17 is configured to transmit the operation system image to the child terminal 40 in response to the request from the child terminal 40 if the number is less than the preset value. The child terminal 40 is configured to receive the operation system image and load the operation system on the child terminal 40 for the user of the child terminal 40 to operate. If the number of child terminals 40 that have obtained the operation system image from the father terminal 30 is greater than the preset value, the image transmitting module 17 transfers the operating system image request to another father terminal 30 to transmit the operating system image to the child terminal 40.

In this exemplary embodiment, the image obtaining module 11, the image requesting module 13, the image recording module 15, and the image transmission module 17 are software programs. The software programs can run in the father terminals 30, the child terminals 40, or the server 20. In an alternative embodiment, some of the software programs run in the father terminals 30, some of the software programs run in the child terminals 40, and some of the software programs run in the server 20.

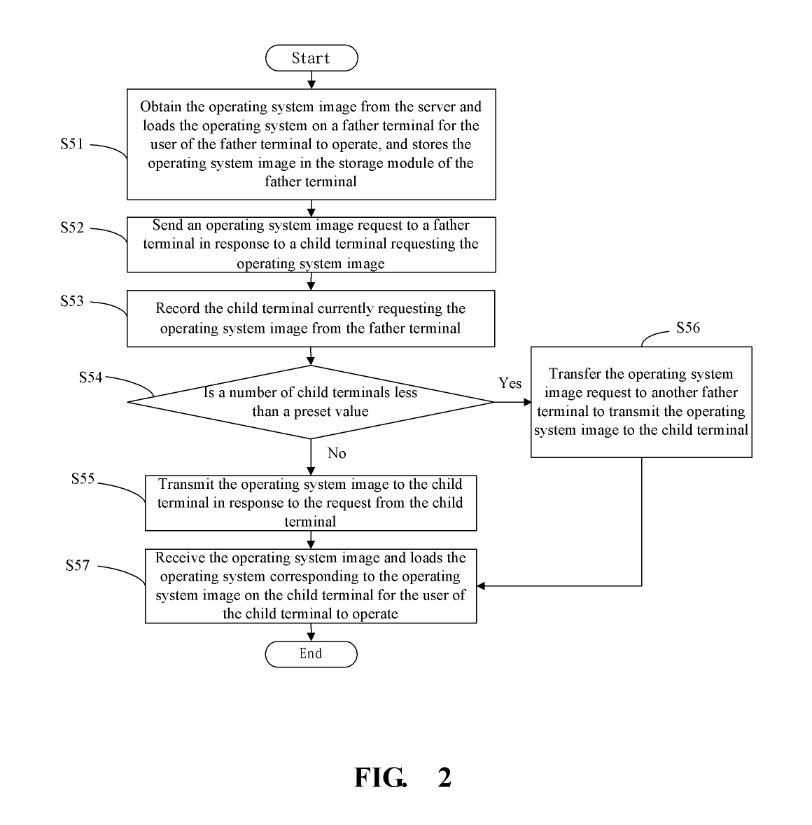

FIG. 2 shows a flowchart of a server cluster deployment method. The server cluster deployment method includes the following steps.

In step S51, the image obtaining module 11 obtains the operation system image from the server 20 and loads the operation system on a father terminal 30 for the user of the father terminal 30 to operate, and stores the operation system image in the storage module 32 of the father terminal 30.

In step S52, the image requesting module 13 sends an operating system image request to a father terminal 30 in response to a child terminal 40 requesting the operating system image.

In step S53, the image recording module 15 records the child terminal 40 currently requesting the operating system image from the father terminal 30.

In step S54, the image recording module 15 determines whether a number of child terminals 40 that have obtained the operating system image from the father terminal 30 is less than a preset value. If the number is less than the preset value, the procedure goes to step S55. Otherwise, the procedure goes to step S56.

In step S55, the image transmitting module 17 transmits the operation system image to the child terminal 40 in response to the request from the child terminal 40.

In step S56, the image transmitting module 17 transfers the operating system image request to another father terminal 30 to transmit the operating system image to the child terminal 40.

In step S57, the child terminal 40 receives the operation system image and loads the operation system corresponding to the operation system image on the child terminal 40 for the user of the child terminal 40 to operate.

The server cluster deployment system 10 and method transmit the operation system image through the father terminal 40. Therefore, a transmission speed of the operation system image is increased.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A server cluster deployment system employed to a server cluster, the server cluster comprising a server, a plurality of father terminals and a plurality of child terminals, the server configured to provide an operation system image to load an operation system corresponding to the operation system image to the father terminals and the child terminals for users to operate the father terminals and the child terminals, the server cluster deployment system comprising:
an image obtaining module configured to obtain the operation system image from the server and load the operation system to an father terminal for the user of said father terminal to operate on said father terminal, and store the operation system image in a storage module of said father terminal;
an image requesting module configured to send a request of obtaining the operation system image from a child terminal to said father terminal;
an image recording module configured to record a number of child terminals which have obtained the operation system image from said father terminal and determines whether the number less than a preset value; and
an image transmitting module configured to transmit the operation system image to said child terminal in respond to the request from said child terminal only when the number is less than the preset value.

2. The television as claimed in claim 1, wherein the image transmitting module is further configured to transmit the request to another father terminal if the number is greater than the preset value, the operation system image is transmitted by said another father terminal to said child terminal in respond to the request.

3. A server cluster deployment method employed to a server cluster, the server cluster comprising a server, a plurality of father terminals and a plurality of child terminals, the server configured to provide an operation system image to load an operation system corresponding to the operation system image to the father terminals and the child terminals for users to operate the father terminals and the child terminals, the server cluster deployment method comprising:
obtaining the operation system image from the server and loading the operation system to an father terminal for the user of said father terminal to operate on said father terminal, and storing the operation system image in a storage module of said father terminal;
sending a request of obtaining the operation system image from a child terminal to said father terminal;
recording a number of child terminals which have obtained the operation system image from said father terminal;
determining whether the number is less than a preset value;
transmitting the operation system image to said child terminal in respond to the request from said child terminal if the number is less than the preset value; and
receiving the operation system image from said father terminal and loading the operation system to said child terminal for the user of said child terminal to operate on said child terminal.

4. The server cluster deployment method as claimed in claim 3, wherein further comprising:
transmitting the request to another father terminal in response to the request from the said child terminal if the number is greater than the preset value; and
receiving the operation system image from said another father terminal and loading the operation system to said child terminal for the user of said child terminal to operate on said child terminal.
